(19) United States
(12) Patent Application Publication
(10) Pub. No.: US 2021/0303113 A1
(43) Pub. Date: Sep. 30, 2021

(54) DISPLAY CONTROL METHOD AND INFORMATION PROCESSING APPARATUS

(71) Applicant: FUJITSU LIMITED, Kawasaki-shi (JP)

(72) Inventor: Shodai Kawatake, Ota (JP)

(73) Assignee: FUJITSU LIMITED, Kawasaki-shi (JP)

(21) Appl. No.: 17/204,029

(22) Filed: Mar. 17, 2021

(30) Foreign Application Priority Data
Mar. 25, 2020 (JP) 2020-054320

(51) Int. Cl. G06F 3/0482; G06F 3/14; G06F 3/16; G06F 3/01; G06F 3/0484; G06Q 10/06

(52) U.S. Cl. CPC G06F 3/0482; G06F 3/14; G06Q 10/0633; G06F 3/012; G06F 3/04845; G06F 3/167

(57) ABSTRACT

A display control method includes specifying, among a plurality of work processes included in a work flow, upon receiving an input of a work result of a first work process of a branching-source with a plurality of branching-destinations defined corresponding to the work result, a second work process of preceding the first work process and a third work process of a branching-destination corresponding to the input of the work result, based on the work flow, generating an image list that includes a first work image associated with the second work process and a second work image associated with the third work process, with reference to a storage device that stores a plurality of work images in association with the plurality of work processes, and causing, upon receiving a specific instruction, the generated image list to be displayed on a display device, by a processor.

### CROSS-REFERENCE TO RELATED APPLICATION

This application is based upon and claims the benefit of priority of the prior Japanese Patent Application No. 2020-54320, filed on Mar. 25, 2020, the entire contents of which are incorporated herein by reference.

### FIELD

The embodiments discussed herein are related to a display control method and an information processing apparatus.

### BACKGROUND

Due to factors such as a shortage of human resources and an increase in the number of facilities, there is a risk that the quality of site operations may deteriorate. Accordingly, Internet of Things (IoT) technology may be used to maintain the quality of site operations.

FIG. 1 is a diagram illustrating a remote support system.

The worker at a site 6 performs work by using navigation based on a work guide transmitted from an office 7 via a cloud 8. The work details may be displayed on a display of a head mounted display (HMD) 61 worn by the worker, or may be output by voice from a speaker of the HMD 61. In the office 7, a support staff gives work instructions to the worker by remote support.

FIG. 2 is a diagram describing a process of displaying mission cards in the remote support system illustrated in FIG. 1.

In FIG. 2, mission cards #1 to #3 (for example, work procedures) are illustrated. As indicated by reference sign A1, the mission card #2 is selected from among the mission cards #1 to #3, and screen information on the mission card #2 is transmitted to the site 6 via the cloud 8. At the site 6, as indicated by reference sign A2, a screen indicating work details is displayed on the HMD 61 of the worker.

Examples of the related art include Japanese Laid-open Patent Publication No. 2015-049695, Japanese Laid-open Patent Publication No. 2009-037392, Japanese Laid-open Patent Publication No. 2005-148869, and Japanese Laid-open Patent Publication No. 2011-197924.

### SUMMARY

According to an aspect of the embodiments, a display control method that causes a computer to execute a procedure, the procedure includes specifying, among a plurality of work processes included in a work flow, upon receiving an input of a work result of a first work process of a branching-source with a plurality of branching-destinations defined corresponding to the work result, a second work process of preceding the first work process and a third work process of a branching-destination of the plurality of branching-destinations corresponding to the input of the work result, based on the work flow, the plurality of work processes including the first work process to the third work process, generating an image list that includes a first work image associated with the second work process and a second work image associated with the third work process, with reference to a storage device that stores a plurality of work images in association with the plurality of work processes, the plurality of work images including the first work image and the second work image, and causing, upon receiving a specific instruction, the generated image list to be displayed on a display device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a remote support system;

FIG. 2 is a diagram describing a process of displaying mission cards in the remote support system illustrated in FIG. 1;

FIG. 3 is a diagram describing an operation process of screen switching by voice commands in the remote support system illustrated in FIG. 1;

FIG. 4 is a block diagram schematically illustrating an example of a hardware configuration of an information processing apparatus according to an embodiment;

FIG. 5 is a block diagram schematically illustrating an example of a software configuration of the information processing apparatus illustrated in FIG. 4;

FIG. 6 is a diagram describing an operation process of switching display of the mission cards in the information processing apparatus illustrated in FIG. 4;

FIG. 7 is a diagram describing details of the operation process of switching display of the mission cards illustrated in FIG. 6;

FIG. 8 is a diagram describing an operation process of switching display modes in the information processing apparatus illustrated in FIG. 4;

FIG. 9 is a flowchart illustrating a work procedure;

FIG. 10 is a diagram describing a display example of the work procedure illustrated in FIG. 9, in the information processing apparatus illustrated in FIG. 4;

FIG. 11 is a diagram illustrating a display example of a work omission alert in the information processing apparatus illustrated in FIG. 4;

FIG. 12 is a flowchart illustrating a specific example of a work procedure;

FIG. 13 is a flowchart illustrating indispensable works in the work procedure illustrated in FIG. 12;

FIG. 14 is a diagram illustrating a detailed example of an operation process for switching the display modes illustrated in FIG. 8;

FIG. 15 is a diagram illustrating a transition example of a mission card list screen in the information processing apparatus illustrated in FIG. 4;

FIG. 16 is a diagram illustrating a specific example of the work omission alert illustrated in FIG. 11;

FIG. 17 is a flowchart describing remote support processing in the information processing apparatus illustrated in FIG. 4; and

FIG. 18 is a flowchart describing a calculation process of the display work list illustrated in FIG. 17.

### DESCRIPTION OF EMBODIMENTS

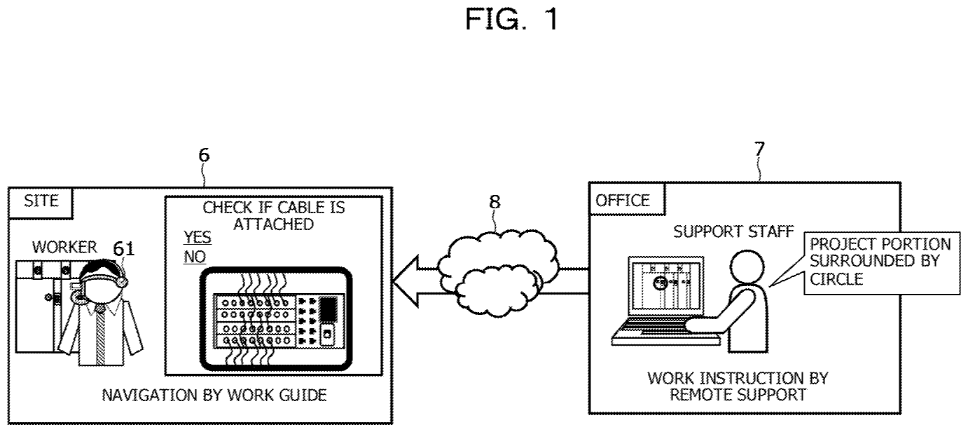

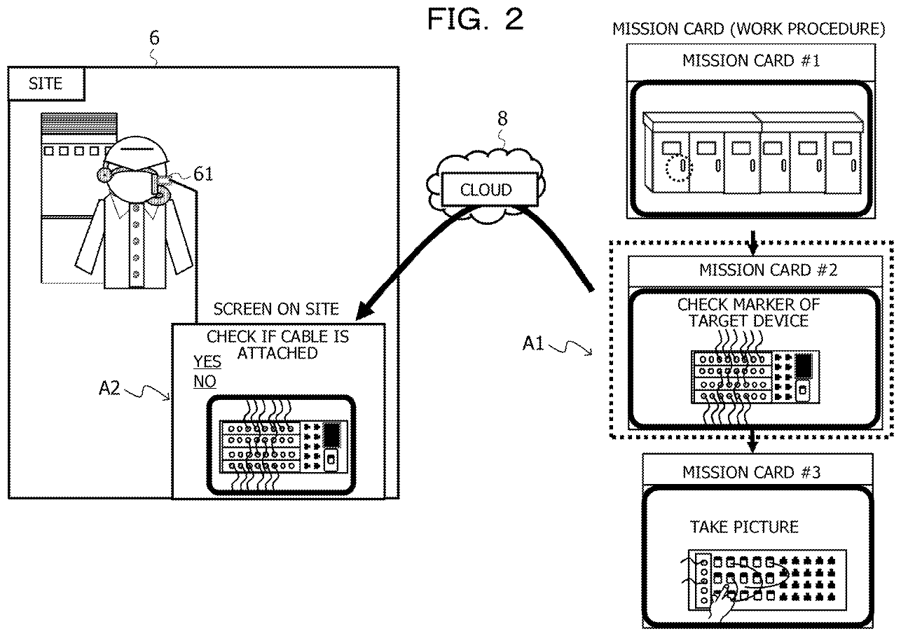

Interfaces usable for operation at the site 6 illustrated in FIGS. 1 and 2 may be limited. For example, the use of a tablet terminal is not suitable for work with both hands, at a high place, or at the time of ascending and descending a ladder, and an HMD 61, for example, is used in such situations. However, the HMD 61 may not be used as a touch pad or may have a small screen. The use of a keyboard or a remote control is not suitable for work with thick gloves, and a microphone for inputting voice commands, for example, is used in such a situation. However, in some cases, it takes time for the microphone to perform an input, or a plurality of inputs may not be made at the same time. For example, the use of a see-through HMD 61 is not suitable for work in which provision of safe eyesight is preferred, and a one-eye HMD 61, for example, is used in such a situation. However, the one-eye HMD 61 may have a small screen.

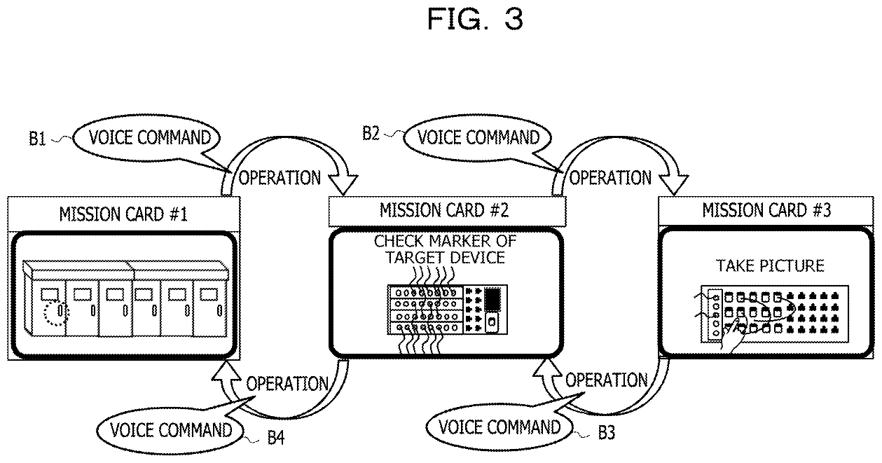

FIG. 3 is a diagram describing an operation process of screen switching by voice commands in the remote support system illustrated in FIG. 1.

As indicated by reference sign B1, when a voice command “next”, for example, is input during display of a mission card #1, the display of the screen is switched to a mission card #2. As indicated by reference sign B2, when the voice command “next”, for example, is input during display of the mission card #2, the display of the screen is switched to a mission card #3. As indicated by reference sign B3, when a voice command “forward”, for example, is input during display of the mission card #3, the display of the screen is switched to the mission card #2. As indicated by reference sign B4, when the voice command “forward”, for example, is input during display of the mission card #2, the display of the screen is switched to the mission card #1.

These voice command inputs perform only discontinuous operations, which may increase the number of operation processes and decrease work efficiency.

Hereinafter, an embodiment of a technique capable of efficiently providing an input interface in a remote support system will be described with reference to the drawings. The following embodiment is merely illustrative and is in no way intended to exclude various modification examples or technical applications that are not explicitly described in the embodiment. For example, the present embodiment may be carried out in various modified forms without departing from the gist thereof.

Each figure is not intended to include only the elements illustrated therein, and thus may include other functions and the like.

Since the same reference signs denote the same or similar components in the drawings, the description of such components is omitted.

### [A] Embodiment

[A-1] Example of System Configuration

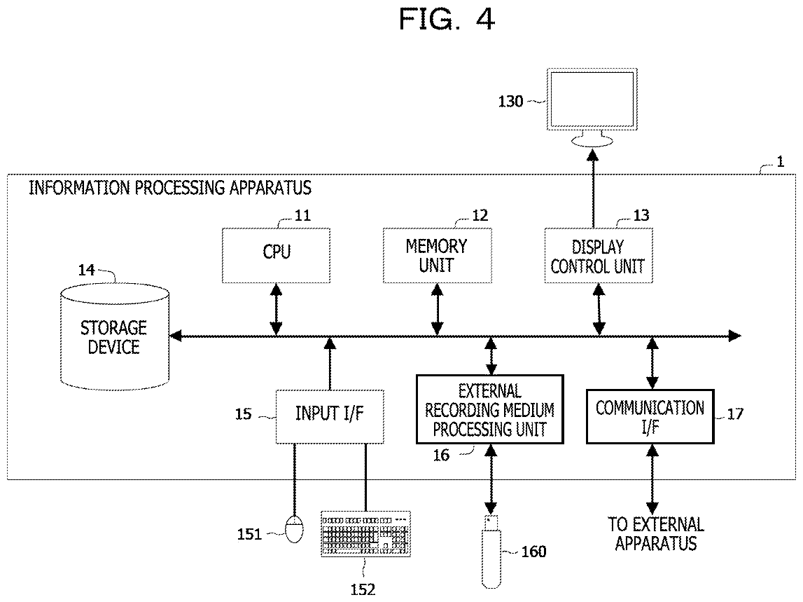

FIG. 4 is a block diagram schematically illustrating an example of a hardware configuration of an information processing apparatus 1 according to an example of an embodiment.

The information processing apparatus 1 may be provided in an office or the like for performing remote support for a worker. As illustrated in FIG. 4, the information processing apparatus 1 includes a CPU 11, a memory unit 12, a display control unit 13, a storage device 14, an input interface (I/F) 15, an external recording medium processing unit 16, and a communication I/F 17.

The memory unit 12 is an example of a storage and includes, for example, a read-only memory (ROM), a random-access memory (RAM), and so on. Programs such as a Basic Input/Output System (BIOS) may be written in the ROM of the memory unit 12. The software programs stored in the memory unit 12 may be appropriately loaded and executed by the CPU 11. The RAM of the memory unit 12 may be utilized as a memory for temporary storage or as a working memory.

The display control unit 13 is coupled to a display device 130 and controls the display device 130. The display device 130 is a liquid crystal display, an organic light-emitting diode (OLED) display, a cathode ray tube (CRT) display, an electronic paper display, or the like and displays various types of information for an operator or the like. The display device 130 may be combined with an input device. For example, the display device 130 may be a touch panel.

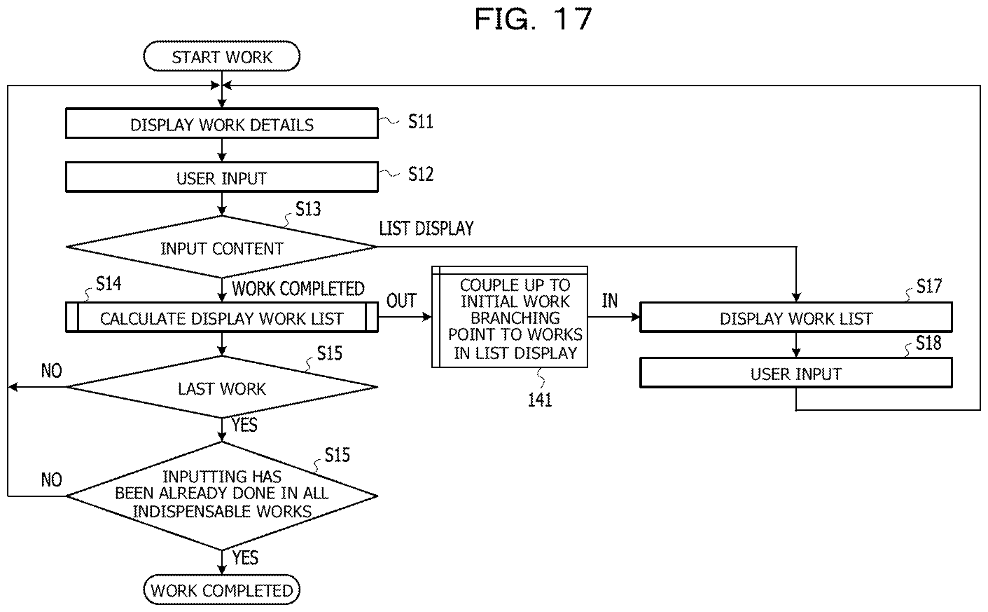

The storage device 14 is a storage device having high input/output performance. For example, a hard disk drive (HDD), a solid-state drive (SSD), or a storage class memory (SCM) may be used as the storage device 14. The storage device 14 stores at least some of entries in the stream data. The storage device 14 stores display work list information 141 described later with reference to FIG. 17.

The input I/F 15 may be coupled to input devices such as a mouse 151 and a keyboard 152 and may control the input devices such as the mouse 151 and the keyboard 152. Each of the mouse 151 and the keyboard 152 is an example of an input device. The operator performs various input operations using these input devices.

The external recording medium processing unit 16 is configured so that a recording medium 160 may be inserted thereto. The external recording medium processing unit 16 is configured to be able to read information recorded on the recording medium 160 in a state in which the recording medium 160 is inserted thereto. In the present example, the recording medium 160 is portable. For example, the recording medium 160 is a flexible disk, an optical disc, a magnetic disk, a magneto-optical disk, a semiconductor memory, or the like.

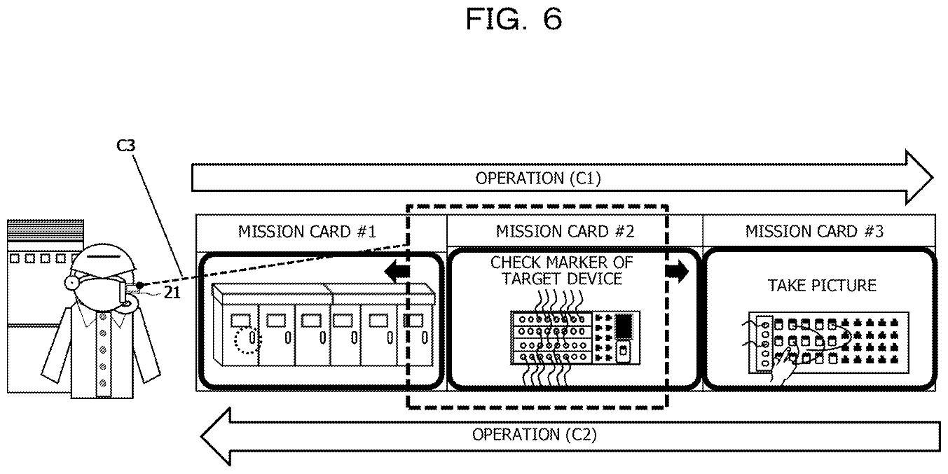

The communication I/F 17 is an interface that enables communication with an external apparatus. The communication I/F 17 transmits an image generated in the information processing apparatus 1 to an HMD 21 (described later with reference to FIG. 6 and the like). The communication I/F 17 receives an input from the HMD 21.

The CPU 11 is a processing device that performs various kinds of control and various computations. The CPU 11 executes an operating system (OS) and the programs stored in the memory unit 12 to implement various functions.

The device that controls the operations of the entire information processing apparatus 1 is not limited to the CPU 11 and may be any one of an MPU, a DSP, an ASIC, a PLD, or an FPGA, for example. The device that controls the operations of the entire information processing apparatus 1 may be a combination of two or more kinds of a CPU, an MPU, a DSP, an ASIC, a PLD, or an FPGA. The MPU is an abbreviation of microprocessor unit. The DSP is an abbreviation of digital signal processor. The ASIC is an abbreviation of application-specific integrated circuit. The PLD is an abbreviation of programmable logic device. The FPGA is an abbreviation of field-programmable gate array.

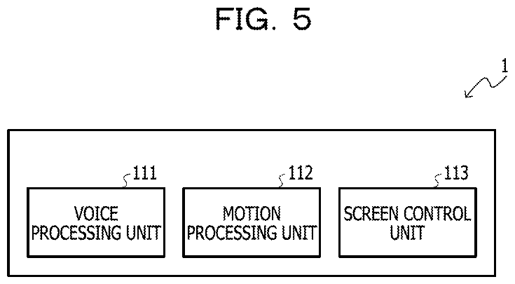

FIG. 5 is a block diagram schematically illustrating an example of a software configuration of the information processing apparatus 1 illustrated in FIG. 4.

The CPU 11 of the information processing apparatus 1 functions as a voice processing unit 111, a motion processing unit 112, and a screen control unit 113.

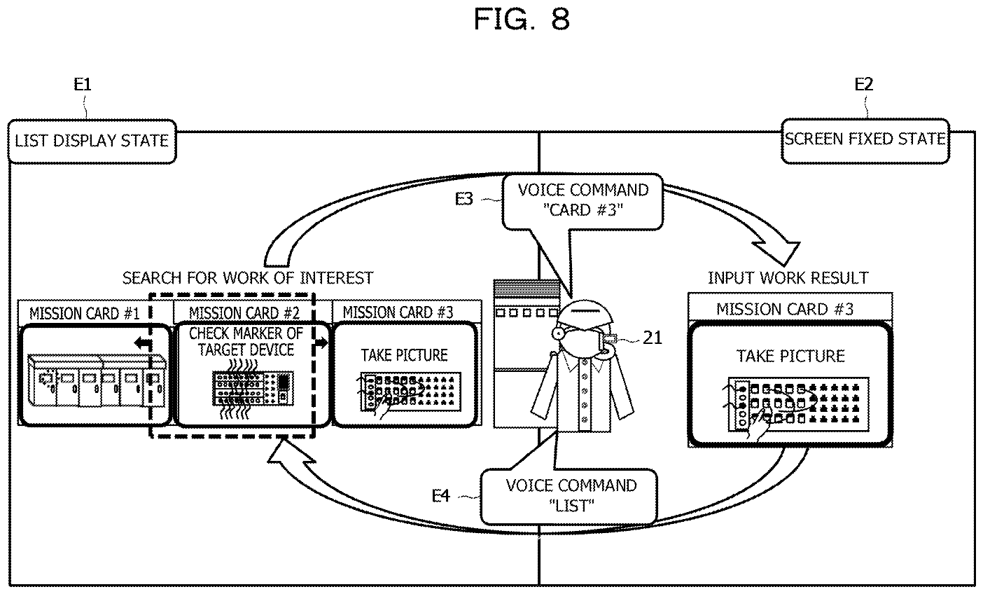

The voice processing unit 111 processes a voice input by the worker to a microphone mounted on the HMD 21. Details of the voice processing unit 111 will be described later with reference to FIG. 8 and the like.

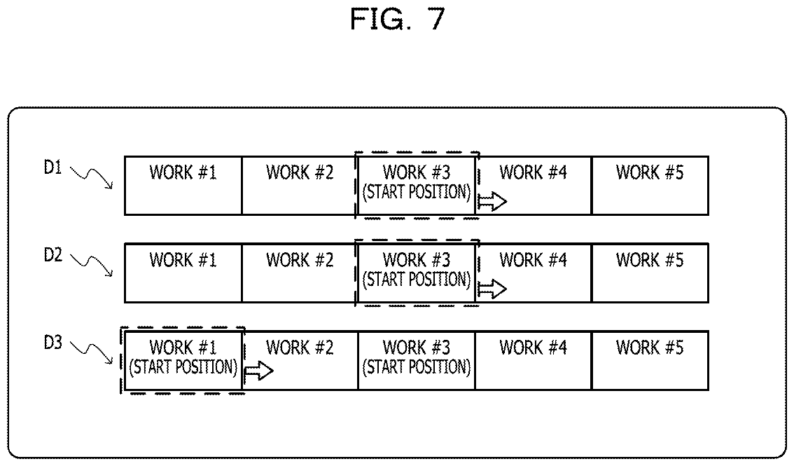

The motion processing unit 112 processes information on a motion input by the worker to a gyro sensor mounted on the HMD 21. Details of the motion processing unit 112 will be described later with reference to FIGS. 6 and 7 and the like.

The screen control unit 113 controls a screen displayed on the display of the HMD 21 based on the inputs from the voice processing unit 111 and the motion processing unit 112. Details of the screen control unit 113 will be described later with reference to FIGS. 6 to 11 and the like.

FIG. 6 is a diagram describing an operation process of switching display of mission cards in the information processing apparatus 1 illustrated in FIG. 4.

A plurality of mission cards (three mission cards #1 to #3 in the illustrated example) to be viewed by the worker on the HMD 21 are coupled in the lateral direction. The worker performs an operation of shaking the head to the right or left (see reference signs C1 and C2) to find a target mission card. Thus, as indicated by reference sign C3, the worker's portion of interest is displayed on the display of the HMD 21. The operation of shaking the head of the worker is detected by the gyro sensor mounted on the HMD 21, and is processed by the motion processing unit 112 of the information processing apparatus 1.

For example, in a state where an image list is displayed on the display of the HMD 21, the screen control unit 113 moves an area in the image list to be displayed on the display of the HMD 21 in accordance with the motion of the user of the HMD 21.

FIG. 7 is a diagram describing details of the operation process of switching display of the mission cards illustrated in FIG. 6.

In the example indicated by reference sign D1, the speed of moving a portion of interest (see the broken line frame) is determined based on the difference in angle between a reference direction (for example, a direction toward the front of the body of the worker) and a direction in which the face of the worker faces. When the state with the difference in angle is maintained, such as when a screen operation of a web browser is performed with a mouse wheel, the portion of interest may also continue to be moved. For example, while the worker is facing the right, the portion of interest continues to be moved to the right, and when the worker is facing the front, the movement of the portion of interest stops.

In the example indicated by reference sign D2, one portion of interest (see the broken line frame) is determined based on the difference in angle between the reference direction and the direction in which the face of the worker faces. For example, in a state where the mission card of the work #3 at the start position is displayed, when the worker turns slightly to the right, the mission card of the work #4 is displayed, and when the worker turns further to the right, the mission card of the work #5 is displayed. When the worker turns the face back to the front, the mission card of the work #3 is displayed again.

In the example indicated by reference sign D3, the acceleration of the movement of the portion of interest (see the broken line frame) is determined in accordance with the force of shaking the head as in a swipe operation on a smartphone or a tablet, and the movement of the portion of interest eventually stops. For example, in a state where the mission card of the work #1 at the start position is displayed, when the head is strongly swung to the right, the portion of interest moves to the right and stops on the mission card of the work #5, and when the head is weakly swung to the right, the portion of interest moves to the right and stops on the mission card of the work #2.

FIG. 8 is a diagram describing an operation process of switching display modes in the information processing apparatus 1 illustrated in FIG. 4.

As illustrated in FIG. 8, the display of the mission cards may be divided into a list display state indicated by reference sign E1 and a screen fixed state indicated by reference sign E2. In the list display state, the worker uses the gyro sensor to search for a mission card on which a work of interest is displayed, and when the worker wants to fix the display of the found mission card, the worker makes a transition to the screen fixed state by a voice command. For example, as indicated by reference sign E3, when the work of interest is searched for and the work is the work of “card #3”, a voice command of “card #3” is input, and the mission card #3 is displayed in a fixed manner. In this way, since the portion of interest does not move due to the movement of the face of the worker, the work result may be easily input. For example, as indicated by reference sign E4, in the screen fixed state, a voice command “list” is input, and the mission card returns to the list display state. The input of a voice command by the worker is detected by the microphone mounted on the HMD 21, and is processed by the voice processing unit 111 of the information processing apparatus 1.

For example, in a state where the image list is displayed on the display of the HMD 21, the screen control unit 113 causes one work image included in the image list to be displayed on the display of the HMD 21 in response to the input of a voice command for specifying the one work image. In a state where any work image included in the image list is displayed on the display of the HMD 21, the screen control unit 113 causes the image list to be displayed on the display of the HMD 21 in response to the input of a voice command indicating the image list.

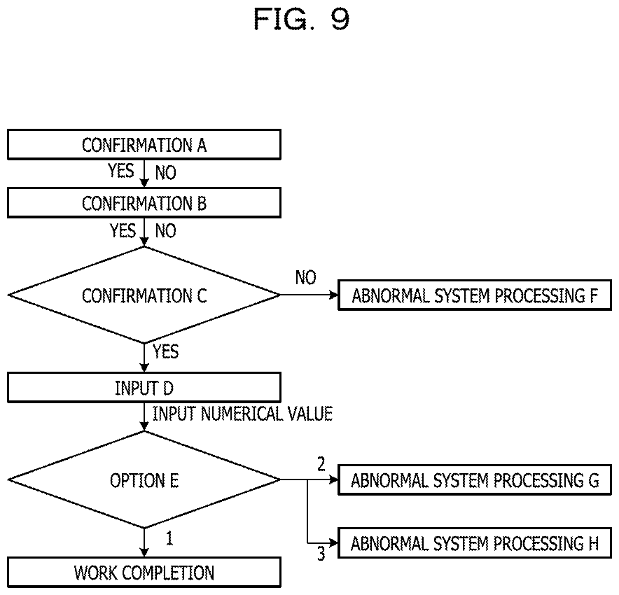

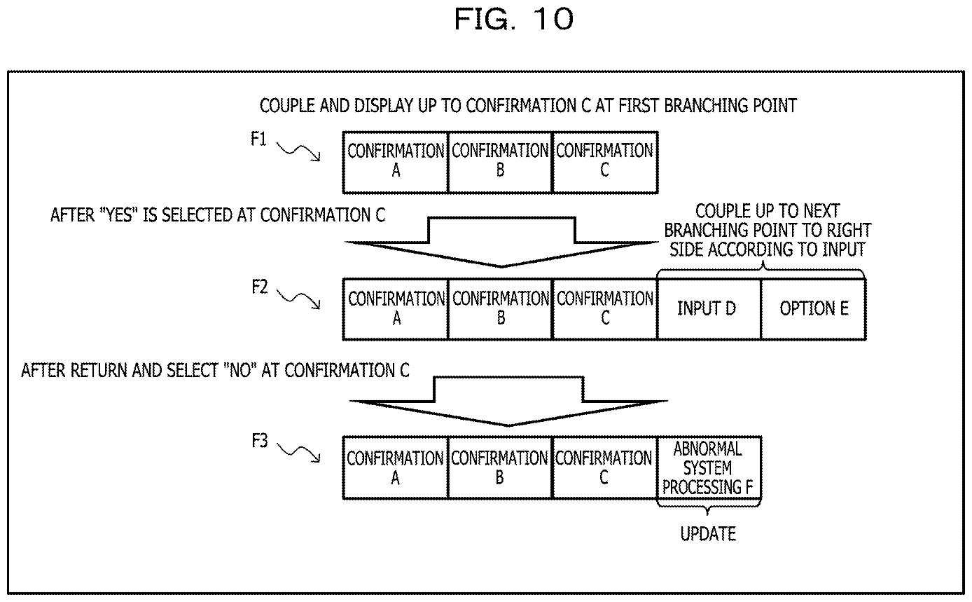

FIG. 9 is a flowchart illustrating a work procedure. FIG. 10 is a diagram describing a display example of the work procedure illustrated in FIG. 9, in the information processing apparatus 1 illustrated in FIG. 4.

In the work procedure illustrated in FIG. 9, the work of confirmation A is performed, the work of confirmation B is performed, and the process branches depending on whether the work result of confirmation C is “YES” or “NO”. When the work result of the confirmation C is “NO”, abnormal system processing F is performed. On the other hand, when the work result of the confirmation C is “YES”, the work of input D is performed, and the process branches depending on whether the work result of option E is “1”, “2”, or “3”. When the work result of the option E is “1”, the work is completed. On the other hand, when the work result of the option E is “2”, abnormal system processing G is executed, and when the work result of the option E is “3”, abnormal system processing H is executed.

In the work procedure illustrated in FIG. 9, as illustrated in FIG. 10, the mission cards up to a work branching point are horizontally coupled, and further subsequent cards are coupled and displayed by an input at the work branching point. As indicated by reference sign F1, the mission cards up to the confirmation C that serves as the initial branching point are coupled and displayed at the beginning. After “YES” is selected in the confirmation C, as indicated by reference sign F2, the input D and the option E on the mission cards up to the next branching point are coupled to the right side in accordance with the input of the work result in the confirmation C. After the worker returns to the mission card of the confirmation C and selects “NO”, as indicated by reference sign F3, the mission cards coupled to the right side of the mission card of the confirmation C are updated to the abnormal system processing F.

For example, the screen control unit 113 functions as an example of a specification unit that, among a plurality of work processes included in a work flow, upon receiving an input of a work result of a branching-source work process with a plurality of branching destinations defined corresponding to a work result, specifying, based on the work flow, a work process preceding the branching-source work process and a branching-destination work process corresponding to the input work result. The screen control unit 113 also functions as an example of a generation unit that generates an image list including a work image associated with the work process preceding the branching-source work process and a work image associated with the branching-destination work process, with reference to the storage device 14 that stores work images in association with work processes. Furthermore, upon receiving a specific instruction, the screen control unit 113 functions as an example of a display processing unit that causes the generated image list to be displayed on the display of the HMD 21. The specific instruction here may be an input of a work result.

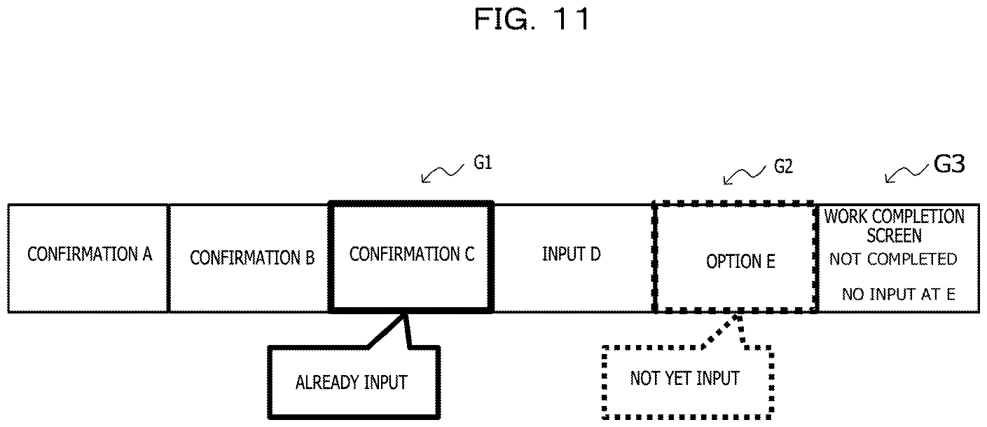

FIG. 11 is a diagram illustrating a display example of a work omission alert in the information processing apparatus 1 illustrated in FIG. 4.

The mission cards involving inputting may be highlighted by coloring or the like. For mission cards involving inputting, different emphasis methods such as coloring or the like may be used for mission cards in which inputting has been already done and mission cards in which inputting has not yet been done. When there is any mission card that involves inputting but in which inputting has not yet been done, a message indicating that work may not be completed may be displayed.

In an example illustrated in FIG. 11, as indicated by reference sign G1, the mission card of the confirmation C is highlighted in a bold frame as a mission card that involves inputting and in which inputting has been already done. As indicated by reference sign G2, the mission card of the option E is highlighted in a dotted line frame as a mission card that involves inputting but in which inputting has not yet been done. As indicated by reference sign G3, the work completion screen displays that the work may not be completed because inputting has not yet been done in the mission card of the option E.

As the mission cards involving inputting, mission cards that serve as branching points and mission cards that involve inputting of values or inputting of work results such as camera shooting may be set.

For example, among a plurality of work processes, the screen control unit 113 sets work processes that serve as branching points and work processes in which work results are to be input, as work processes that involve inputting. Among the work processes that involve inputting, the screen control unit 113 causes work processes in which inputting has been already done and work processes in which inputting has not yet been done to be highlighted such that these work processes are distinguishable from each other. The work process that serves as the branching point may be the branching-source work process.

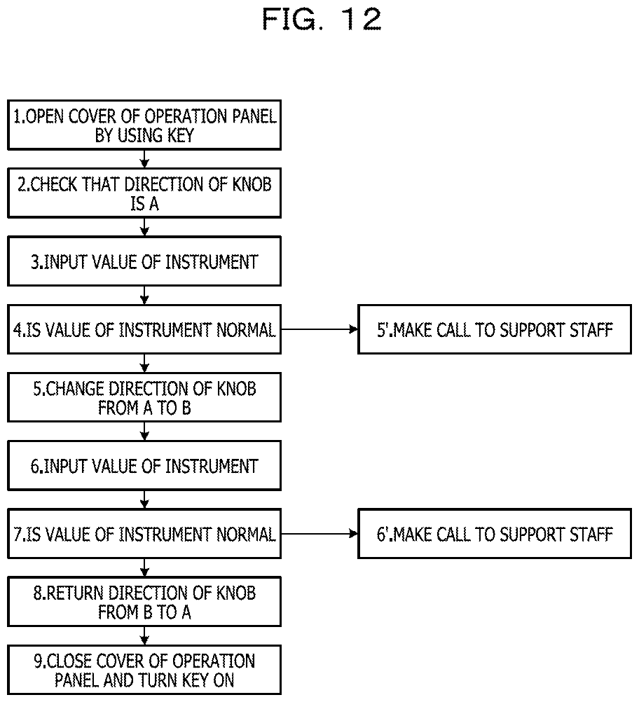

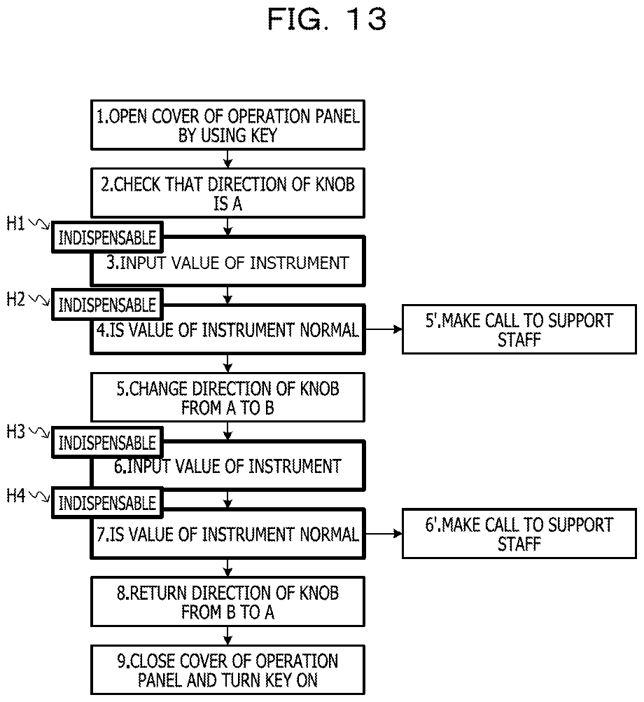

FIG. 12 is a flowchart illustrating a specific example of a work procedure. FIG. 13 is a flowchart illustrating indispensable works in the work procedure illustrated in FIG. 12.

The work illustrated in FIG. 12 is “checking a value of an instrument while moving a knob”. For example, the worker uses a key to open the cover of the operation panel in work #1, checks that the direction of the knob is A in work #2, inputs the value of the instrument in work #3, and performs an input indicating whether the value of the instrument is normal in work #4. When the value of the instrument is abnormal in the work #4, the worker makes a telephone call to a support staff in work #5′, and on the other hand, when the value of the instrument is normal in the work #4, the worker changes the direction of the knob from A to B in work #5. The worker inputs the value of the instrument in work #6, and performs an input indicating whether the value of the instrument is normal in work #7. When the value of the instrument is abnormal in the work #7, the worker makes a telephone call to a support staff in work #8′, and on the other hand, when the value of the instrument is normal in the work #7, the worker returns the direction of the knob from B to A in work #8. The worker closes the cover of the operation panel and turns on the key in work #9, whereby the work is completed.

As illustrated in FIG. 13, in the operation procedure illustrated in FIG. 12, works #3, #4, #6, and #7 are automatically set to mission cards involving inputting, as mission cards involving inputting of work results or as mission cards serving as branching points, as indicated by reference sign H1 to reference sign H4.

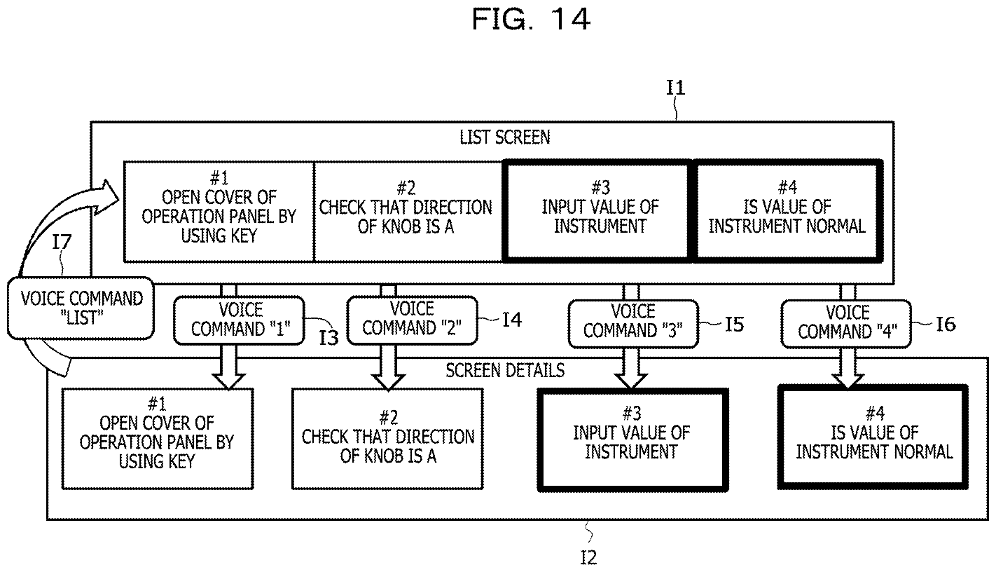

FIG. 14 is a diagram illustrating a detailed example of the operation process for switching the display modes illustrated in FIG. 8.

In the illustrated example, switching takes place between a list screen indicated by reference sign I1 and screen details indicated by reference sign I2. In the list screen indicated by reference sign I1, mission cards up to the initial option are coupled and displayed. The mission cards involving inputting may be highlighted. Switching between the list screen and the screen details is performed by voice commands.

For example, on the list screen, when a voice command “1” as indicated by reference sign I3 is input, the screen details of the mission card #1 are displayed, and when a voice command “2” as indicated by reference sign I4 is input, the screen details of the mission card #2 are displayed. On the list screen, when a voice command “3” as indicated by reference sign I5 is input, the screen details of the mission card #3 are displayed, and when a voice command “4” as indicated by reference sign 16 is input, the screen details of the mission card #4 are displayed. In the screen details, when a voice command “list” as indicated by reference sign I7 is input, a list screen of the mission cards is displayed.

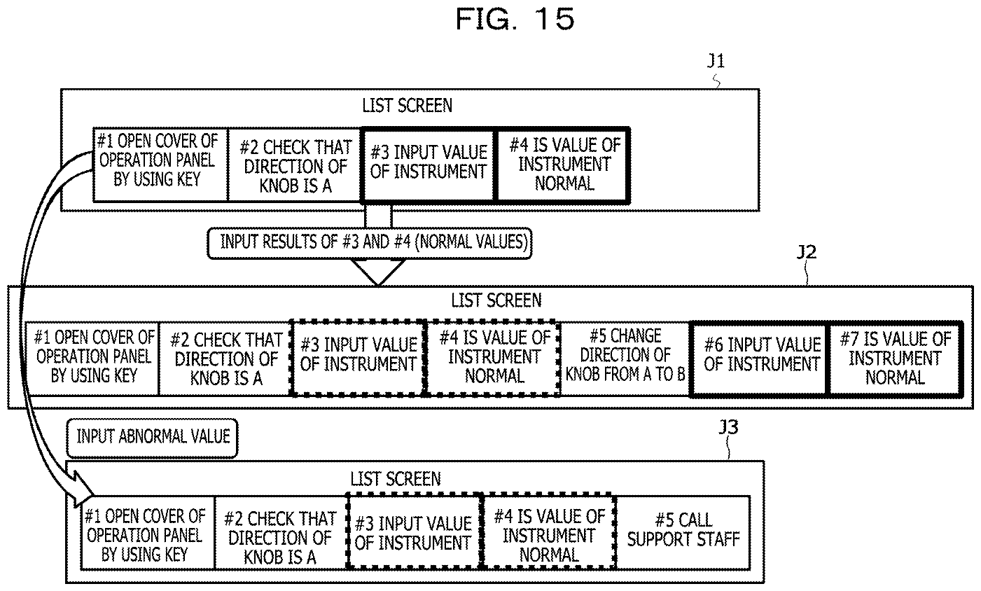

FIG. 15 is a diagram illustrating a transition example of a mission card list screen in the information processing apparatus 1 illustrated in FIG. 4.

As indicated by reference sign J1, mission cards #1 to #4 are displayed on the list screen, and the mission cards #3 and #4 are set to mission cards involving inputting (see bold line frames). When normal values are input as the work results of the mission cards #3 and #4, mission cards #5 to #7 are displayed on the list screen in addition to the mission cards #1 to #4 as indicated by reference sign J2. The mission cards #3 and #4 are displayed in dotted line frames indicating indispensable works with inputting having been already done, and the mission cards #6 and #7 are displayed in bold line frames indicating indispensable works with inputting having not yet been done. When abnormal values are input as work results of the mission cards #3 and #4 in the state of the list screen indicated by reference sign J1, the mission card #5 instructing “Call support staff” is displayed as indicated by reference sign J3, in addition to the mission cards #1 to #4. The mission cards #3 and #4 are displayed in dotted line frames as indispensable works with inputting having been already done.

In this way, the display of the list screen is shifted to dynamically couple to the mission card of the next option depending on the work result.

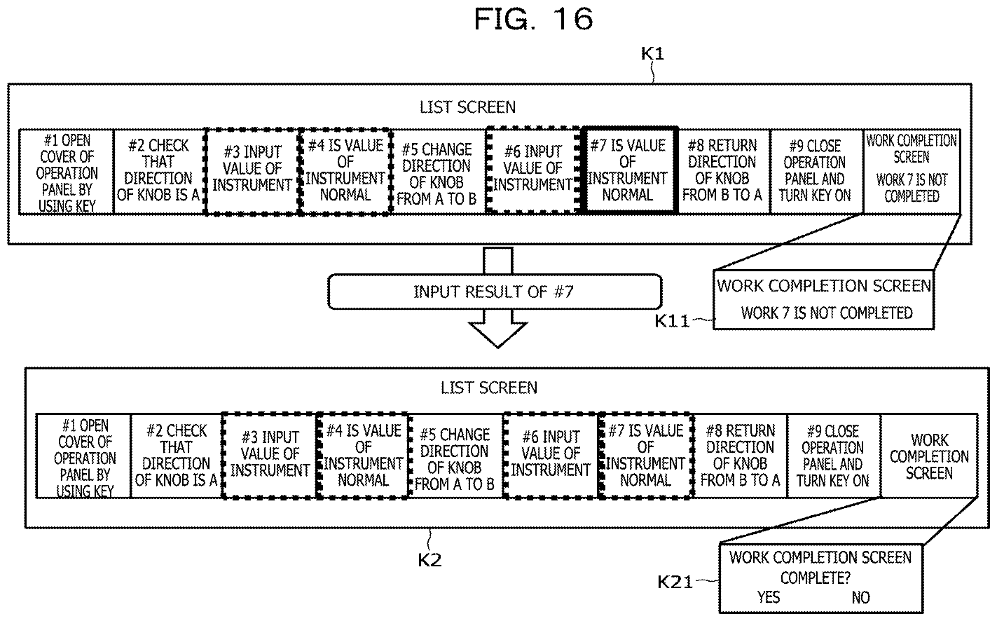

FIG. 16 is a diagram illustrating a specific example of work omission alert illustrated in FIG. 11.

Mission cards #1 to #9 and a work completion screen are displayed on a list screen indicated by reference sign K1. The mission cards #3, #4, and #6 are highlighted in dotted line frames as inputting having been already done, but the mission card #7 is highlighted in a bold line frame as inputting having not yet been done. Thus, when there is a mission card with inputting having not yet been done, a message indicating that the work may not be completed is displayed on the work completion screen as indicated by reference sign K11.

When the work result of the mission card #7 is input in the state of the list screen indicated by reference sign K1, the mission card #7 is highlighted in a dotted line frame as inputting having been already input as indicated by reference sign K2. As indicated by reference sign K21, a screen for asking the worker to confirm whether to complete the work is displayed on the work completion screen.

[A-2] Example of Operation

The remote support processing in the information processing apparatus 1 illustrated in FIG. 4 will be described with reference to a flowchart (operations S11 to S18) illustrated in FIG. 17.

When the work is started, the screen control unit 113 causes work details to be displayed on the display of the HMD 21 (operation S11).

The voice processing unit 111 and the motion processing unit 112 accept inputs from a user (for example, a worker) (operation S12).

The screen control unit 113 determines whether the input content is input of a work result or list display (operation S13).

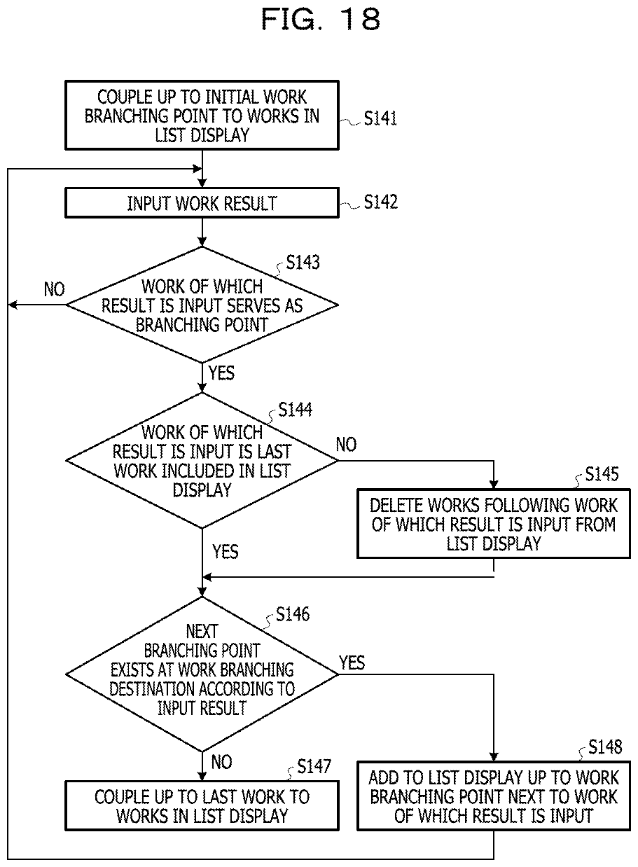

When the input content is input of a work result (see “work result input” route in operation S13), the screen control unit 113 performs a display work list calculation and causes the display work list information 141 to be stored in the storage device 14 (operation S14). Details of the display work list calculation will be described later with reference to FIG. 18.

The screen control unit 113 determines whether the mission card currently being processed indicates the last work (operation S15).

When the work indicated in the mission card being currently processed is not the last work (see NO route in operation S15), the process returns to operation S11.

On the other hand, when the work indicated in the mission card being currently processed is the last work (see YES route in operation S15), the screen control unit 113 determines whether inputting has been already done in all of the indispensable works (operation S16).

When inputting has not yet been done in at least some of the indispensable works (see NO route in operation S16), the process returns to operation S11.

On the other hand, when inputting has been already done in all of the indispensable works (see YES route in operation S16), the works are completed, and the remote support processing is terminated.

In operation S13, when the input content is list display (see “list display” route in operation S13), the screen control unit 113 causes a work list to be displayed based on the display work list information 141 (operation S17).

The voice processing unit 111 and the motion processing unit 112 accept inputs from the user (operation S18), and the process returns to operation S11.

Next, the calculation process of the display work list illustrated in FIG. 17 will be described with reference to a flowchart (operations S141 to S148) illustrated in FIG. 18.

The screen control unit 113 couples the mission cards up to the initial work branching point to the mission cards of which a list is to be displayed (operation S141).

The voice processing unit 111 and the motion processing unit 112 accept inputs from the user (operation S142).

The screen control unit 113 determines whether the work of which the result has been input serves as a branching point (operation S143).

When the work of which the result has been input does not serve as a branching point (see NO route in operation S143), the process returns to operation S142.

On the other hand, when the work of which the result has been input serves as a branching point (refer to YES route in operation S143), the screen control unit 113 determines whether the work of which the result has been input is the last work included in the list display (operation S144).

When the work of which the result has been input is not the last work included in the list display (see NO route in operation S144), the screen control unit 113 deletes, from the list display, the mission cards of the works following the work of which the result has been input (operation S145). The process proceeds to operation S146.

On the other hand, when the work of which the result has been input is the last work included in the list display (see YES route in operation S144), the screen control unit 113 determines whether there is a next branching point at the branching destination of the work in accordance with the input result (operation S146).

When there is no next branching point at the branching destination of the work in accordance with the input result (see NO route in operation S146), the screen control unit 113 couples the mission cards of the works up to the last work to the mission cards of the works included in the list display (operation S147). The process returns to operation S142.

When there is a next branching point at the branching destination of the work in accordance with the input result (refer to YES route in operation S146), the screen control unit 113 adds the mission cards of the works up to the work branching point next to the work of which the result has been input (operation S148). The process returns to operation S142.

[A-3] Effects

According to the display control method, the information processing apparatus 1, and the display control program in the example of the embodiment described above, the following effects may be obtained, for example.

Among a plurality of work processes included in a work flow, upon receiving an input of a work result of a branching-source work process with a plurality of branching destinations defined corresponding to a work result, the screen control unit 113 specifies, based on the work flow, a work process preceding the branching-source work process and a branching-destination work process corresponding to the input work result. The screen control unit 113 also generates an image list including a work image associated with the work process preceding the branching-source work process and a work image associated with the branching-destination work process, with reference to the storage device 14 that stores work images in association with work processes. Furthermore, upon receiving a specific instruction, the screen control unit 113 causes the generated image list to be displayed on the display of the HMD 21.

Thus, an efficient input interface may be provided in the remote support system. For example, while work images corresponding to branching results are extracted and included in the image list, whereas work images of work processes that are not to be actually performed are excluded in the image list. This improves the visibility of the image list. The storage capacity of the HMD 21 would not be consumed for storing screen lists corresponding to the routes that are not to be actually used, so that the storage capacity of the HMD 21 may be reduced.

The specific instruction is an input of a work result. Thus, the worker starts the work based on the displayed work image, and coupling processing of the work images is performed within the work time, which causes no waiting time for completion of the coupling processing. For example, generation of the image list may be completed by the timing of issuing an instruction for displaying the image list.

Among a plurality of work processes, the screen control unit 113 sets work processes that serve as branching points and work processes in which work results are to be input, as work processes that involve inputting. Thus, the worker may visually recognize the work processes that involve inputting.

Among the work processes that involve inputting, the screen control unit 113 causes work processes in which inputting has been already done and work processes in which inputting has not yet been done to be highlighted such that these work processes are distinguishable from each other. Thus, the worker may visually recognize the work processes in which inputting has been already done and the work processes in which inputting has not yet been done.

In a state where the image list is displayed on the display of the HMD 21, the screen control unit 113 causes one work image included in the image list to be displayed on the display of the HMD 21 in response to the input of a voice command for specifying the one work image. In a state where any work image included in the image list is displayed on the display of the HMD 21, the screen control unit 113 causes the image list to be displayed on the display of the HMD 21 in response to the input of a voice command indicating the image list. Thus, even when the hands of the worker are full, the worker may easily switch between the image list screen and each work screen on the display of the HMD 21.

In a state where the image list is displayed on the display of the HMD 21, the screen control unit 113 moves an area in the image list to be displayed on the display of the HMD 21 in accordance with the motion of the user of the HMD 21. Thus, even when the hands of the worker are full, the worker may easily move the display area of the image list on the display of the HMD 21.

### [B] Others

The technique disclosed herein is not limited to the above-described embodiment and may be variously modified and carried out without departing from the gist of the present embodiment. Each of the configurations described in the embodiment and each of the processes described in the embodiment may be selected. Alternatively, two or more of the configurations described in the embodiment may be combined, and two or more of the processes described in the embodiment may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A display control method that causes a computer to execute a procedure, the procedure comprising:
specifying, among a plurality of work processes included in a work flow, upon receiving an input of a work result of a first work process of a branching-source with a plurality of branching-destinations defined corresponding to the work result, a second work process of preceding the first work process and a third work process of a branching-destination of the plurality of branching-destinations corresponding to the input of the work result, based on the work flow, the plurality of work processes including the first work process to the third work process;
generating an image list that includes a first work image associated with the second work process and a second work image associated with the third work process, with reference to a storage device that stores a plurality of work images in association with the plurality of work processes, the plurality of work images including the first work image and the second work image; and
causing, upon receiving a specific instruction, the generated image list to be displayed on a display device.

2. The display control method according to claim 1, wherein the specific instruction is an input of the work result.

3. The display control method according to claim 1, the procedure further comprising:
setting, among the plurality of work processes, the first work process that serves as a branching point and a fourth work process in which the work result is to be input, as a fifth work process that involve inputting.

4. The display control method according to claim 3, the procedure further comprising:
causing, among a plural fifth work process, a work process in which inputting has been already done and a work process in which inputting has not yet been done to be highlighted such that these work processes are distinguishable from each other.

5. The display control method according to claim 1, the procedure further comprising:
in a state where the image list is displayed on the display device, displaying one work image included in the image list on the display device in response to an input of a voice command for specifying the one work image; and
in a state where any work image included in the image list is displayed on the display device, causing the image list to be displayed on the display device in response to an input of a voice command for indicating the image list.

6. The display control method according to claim 1, the procedure further comprising:
in a state where the image list is displayed on the display device, moving an area in the image list to be displayed on the display device in accordance with motion of a user of the display device.

7. An information processing apparatus comprising:
a memory; and
a processor coupled to the memory and configured to:
specify, among a plurality of work processes included in a work flow, upon receiving an input of a work result of a first work process of a branching-source with a plurality of branching-destinations defined corresponding to the work result, a second work process of preceding the first work process and a third work process of a branching-destination of the plurality of branching-destinations corresponding to the input of the work result, based on the work flow, the plurality of work processes including the first work process to the third work process;
generate an image list that includes a first work image associated with the second work process and a second work image associated with the third work process, with reference to a storage device that stores a plurality of work images in association with the plurality of work processes, the plurality of work images including the first work image and the second work image; and
cause, upon receiving a specific instruction, the generated image list to be displayed on a display device.

8. The information processing apparatus according to claim 7, wherein the specific instruction is an input of the work result.

9. The information processing apparatus according to claim 7, wherein the processor is further configured to set, among the plurality of work processes, the first work process that serves as a branching point and a fourth work process in which the work result is to be input, as a fifth work process that involve inputting.

10. The information processing apparatus according to claim 9, wherein the processor is further configured to cause, among a plural fifth work process, a work process in which inputting has been already done and a work process in which inputting has not yet been done to be highlighted such that these work processes are distinguishable from each other.

11. The information processing apparatus according to claim 7, wherein the processor is further configured to:
in a state where the image list is displayed on the display device, display one work image included in the image list on the display device in response to an input of a voice command for specifying the one work image; and
in a state where any work image included in the image list is displayed on the display device, cause the image list to be displayed on the display device in response to an input of a voice command for indicating the image list.

12. The information processing apparatus according to claim 7, wherein the processor is further configured to, in a state where the image list is displayed on the display device, move an area in the image list to be displayed on the display device in accordance with motion of a user of the display device.

13. A non-transitory computer-readable recording medium having stored a program that causes a computer to perform a procedure, the procedure comprising:
specifying, among a plurality of work processes included in a work flow, upon receiving an input of a work result of a first work process of a branching-source with a plurality of branching-destinations defined corresponding to the work result, a second work process of preceding the first work process and a third work process of a branching-destination of the plurality of branching-destinations corresponding to the input of the work result, based on the work flow, the plurality of work processes including the first work process to the third work process;
generating an image list that includes a first work image associated with the second work process and a second work image associated with the third work process, with reference to a storage device that stores a plurality of work images in association with the plurality of work processes, the plurality of work images including the first work image and the second work image; and
causing, upon receiving a specific instruction, the generated image list to be displayed on a display device.

14. The non-transitory computer-readable recording medium according to claim 13, wherein the specific instruction is an input of the work result.

15. The non-transitory computer-readable recording medium according to claim 13, the procedure further comprising:
setting, among the plurality of work processes, the first work process that serves as a branching point and a fourth work process in which the work result is to be input, as a fifth work process that involve inputting.

16. The non-transitory computer-readable recording medium according to claim 15, the procedure further comprising:
causing, among a plural fifth work process, a work process in which inputting has been already done and a work process in which inputting has not yet been done to be highlighted such that these work processes are distinguishable from each other.

17. The non-transitory computer-readable recording medium according to claim 13, the procedure further comprising:
in a state where the image list is displayed on the display device, displaying one work image included in the image list on the display device in response to an input of a voice command for specifying the one work image; and
in a state where any work image included in the image list is displayed on the display device, causing the image list to be displayed on the display device in response to an input of a voice command for indicating the image list.

18. The non-transitory computer-readable recording medium according to claim 13, the procedure further comprising:
in a state where the image list is displayed on the display device, moving an area in the image list to be displayed on the display device in accordance with motion of a user of the display device.
